(19) United States
(12) Patent Application Publication
(10) Pub. No.: US 2008/0275176 A1
(43) Pub. Date: Nov. 6, 2008

(54) Silylated Polymer Emulsion and Its Preparation Method and Uses Thereof

(75) Inventors: Wu Limin, Shanghai (CN); You Bo, Shanghai (CN); Huang Huang, Shanghai (CN)

Correspondence Address: LOCTITE CORPORATION, 1001 TROUT BROOK CROSSING, ROCKY HILL, CT, 06067, US

(73) Assignee: Henkel AG & Co. KGaA, Dusseldorf (DE)

(21) Appl. No.: 12/158,361

(22) PCT Filed: Dec. 20, 2006
(86) PCT No.: PCT/IB06/03721

§ 371 Date: Jun. 20, 2008

(30) Foreign Application Priority Data
Dec. 21, 2005 (CN) 200510133811.X

(51) Int. Cl. C08L 101/10; C08K 3/36

(52) U.S. Cl. 524/493; 524/588

(57) ABSTRACT

The present invention relates to a stable silylated polymer emulsion and its preparation method and uses. The present emulsion comprises a silylated polymer, water, nano silica and an optional emulsifying agent. By using the preparation method of the invention, nano silica can be homogeneously dispersed in a silylated polymer. Without any surface modification, nano silica can be directly added to the silylated polymer and has good compatibility with the silylated polymer. The prepared emulsion has a solid content of <85%, a particle size of less than 3 μm, being of a low VOC content that well meets the environmental protection requirements, and a shelf life of over half a year when stored at room temperature. After volatilization of water, the emulsion can crosslink to form an elastomer, wherein nano silica can play a role of enhancing the mechanical strength of the crosslinked polymer. In use, the emulsion can be directly diluted with water. The emulsion can be used for formulating coatings, adhesives, sealants, inks, skin care products and detergents.

### BACKGROUND OF THE INVENTION

### Technical Field

The present invention relates to a stable silylated polymer emulsion. More particularly, the present invention relates to an aqueous silylated polymer emulsion, which comprises a silylated polymer, water, nano silica and an optional emulsifying agent. The present invention also relates to a method for preparing the stable silylated polymer emulsion and to uses of the same. Use of the invention can be made in the field of adhesives, sealants, coatings, inks, skin care products and detergents, among others.

### Brief Description of Related Technology

A silylated polymer, e.g., a polymer having alkoxysilyl groups at chain end(s) and/or at side chain(s), can self-crosslink with moisture in air or react with a curing agent to obtain a crosslinked polymer, owing to the presence of the reactive alkoxysilyl groups therein. The crosslinked polymer possesses excellent properties. It is widely used in various fields such as adhesives, sealants, coatings, inks, skin care products and detergents. However, during its application, the general situation is that organic solvent is used as a carrier. It is desirable to prepare an aqueous emulsion of the above polymer, following increasingly stricter regulatory constraints on volatile organic compound content.

For polymers insoluble in water, “post-emulsification” is often used in the prior art to prepare aqueous emulsions of the polymers. This is done by dispersing polymer in water under high shear speed to prepare an aqueous polymer emulsion. The emulsifier attaches itself to the surface of the polymer droplets through its lipophilic groups, whereas its hydrophilic groups extend to the water. Owing to charge repulsion or spatial shielding therein, the polymer emulsion particles are prevented from approaching and re-aggregating with each other. U.S. Pat. Nos. 6,713,558 and 6,831,128 introduced a high solid-content silylated viscoelastic polymer emulsion, wherein a silylated polybutadiene polymer, a plasticizer, a surfactant, a low molecular weight acid and water were used for the preparation of an aqueous polymer emulsion having a solid content of greater than 75% and an average particle diameter of less than 5 μm. However, due to the high viscosity of the polymer, a large quantity of emulsifier, low molecular weight plasticizer or co-solvent was required for obtaining the aqueous polymer emulsion. Whereas, since the emulsifier or plasticizer is mostly low molecular weight compound, its addition to the polymer in a large quantity would influence properties of the crosslinked polymer. Further, the addition of a co-solvent would increase the content of VOC in the emulsion, and thus it was no good to the environmental protection. Moreover, it was observed that latex particles in the aqueous polymer emulsion obtained by the above method had irregular particle shape and broad particle size distribution, which caused that a phase separation easily occurred, and the emulsion had poor stability.

Another method for polymers insoluble in water to prepare aqueous emulsions of the polymers is realized by “self-emulsification”, which was done by introducing hydrophilic groups onto the polymer molecule. For example, U.S. Pat. No. 5,466,729 introduced an aqueous dispersion of a silylated epoxy resin. The silylated epoxy resin was obtained by reacting a silane having both a hydrolysable group and a secondary amine group with an epoxy resin. The aqueous dispersion was directly prepared from the silylated epoxy resin under a high shear speed, which can be used in metal coating and glass adhesive. Aqueous polymer emulsion prepared by chemical modification was featured with a small particle size of disperse phase in the range of about tens to hundreds of nanometers, but the preparation process is difficult to control and the product cost is relatively higher. Moreover, due to the change in the molecular structure of polymer in the aqueous polymer emulsion prepared by this method, the properties of the product were somewhat influenced.

Owing to its unique optical, electrical, magnetic and mechanical properties, nano silica is widely used in various fields such as polymer composites, rubber, plastics, coatings, adhesives, sealants and ceramics. However, since nano silica is easily aggregated and has a poor compatibility with resin, it is difficult to directly add it to polymers. Generally, nano silica should be treated by surface modification prior to use, which would increase its application cost.

### SUMMARY OF THE INVENTION

The invention provides a stable silylated polymer emulsion. The stable emulsion can be obtained only using a small quantity of surfactant or even without the use of surfactant. After volatilization of water therein, it can be cured to form a crosslinked elastic film having excellent properties. Said emulsion could be an emulsion of low volatile organic compounds (referred to as low VOC hereinafter).

The invention also provides a simple and easy-to-operate method for the preparation of the stable silylated polymer emulsion.

The invention further provides a method for homogeneously dispersing nano silica into a silylated polymer.

The invention still further provides the stable silylated polymer emulsion for use as a raw material in the fields of coatings, adhesives, sealants, inks, skin care products, detergents and the like.

### DESCRIPTION OF THE ACCOMPANYING DRAWINGS

FIG. 1 is a sectional SEM of a crosslinked polymer sample obtained from the silylated polymer emulsion containing 5 wt % nano silica obtained in Example 2 after volatilization of water, it is enlarged by 10,000 times, from which it can be seen that nano silica is homogeneously dispersed in the crosslinked polymer.

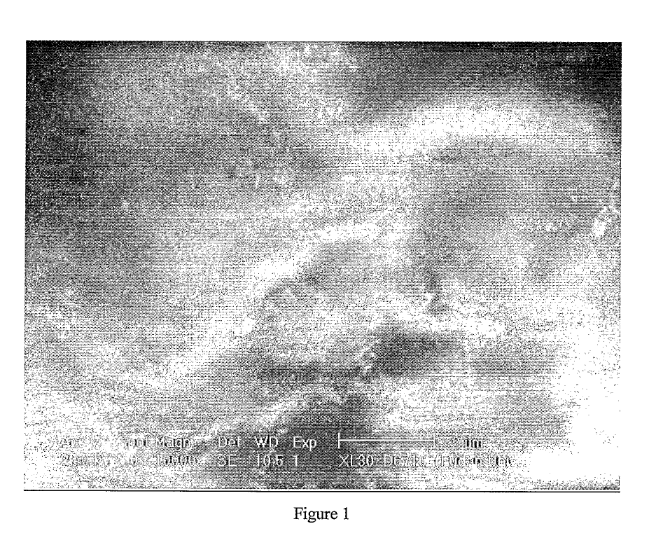

FIG. 2 is a view of the contrast of FTIR spectra of nano silica separated from the silylated polymer emulsion containing nano silica in Example 2 and washed; originally added nano silica; and originally added silylated polymer, from which it can be seen that nano silica in the silylated polymer emulsion has silylated polymer grafted thereon.

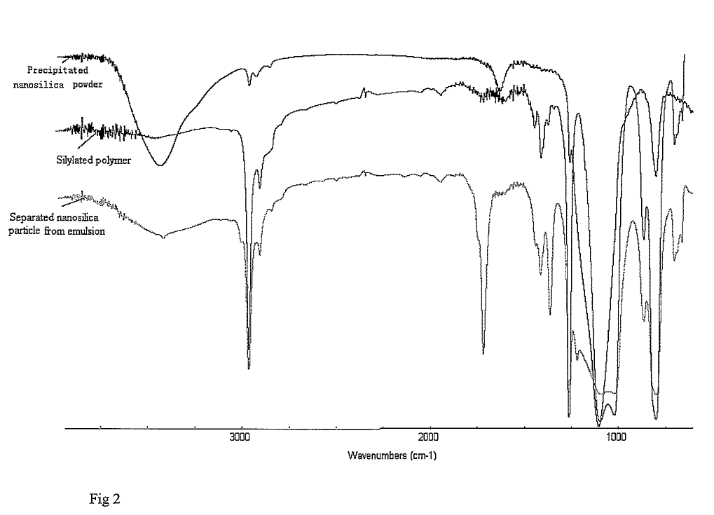

FIG. 3 is a view of the particle size distribution of the silylated polymer emulsion containing 5 wt % nano silica obtained in example 2, the average particle size is 400 nm, from which it can be seen that the particle size of the emulsion is less than 1 μm and having a narrow distribution.

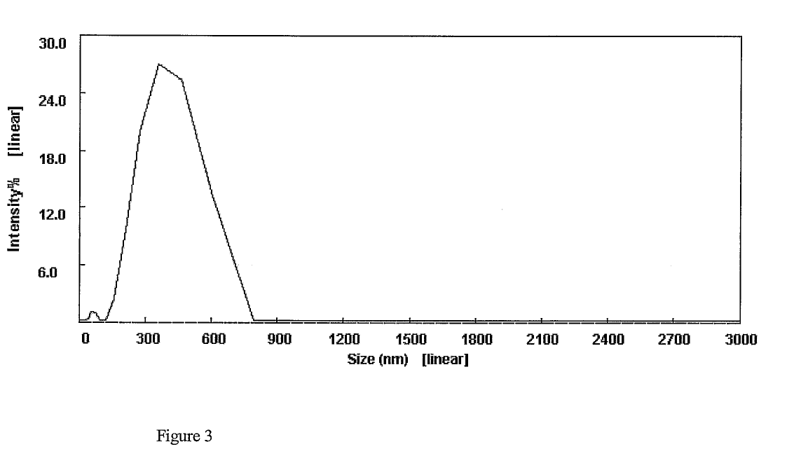

### DETAILED DESCRIPTION OF THE INVENTION

The term “Pickering emulsifying agent” used herein means solid fine particles added for stabilizing emulsion during the preparation of an emulsion. See Pickering, S. U. J. Chem. Soc., Chem. Commun, 1907, 91, 2001; and B. P. Binks and S. O. Lumsdon Langmuir, 2001, 17, 4540-4547.

The term “post-emulsification” used herein means a method of preparing an aqueous polymer emulsion by first preparing a polymer via a conventional process and then dispersing the polymer into water.

The term “low VOC” used herein means the content of VOC in the emulsion is below 1 wt %.

The term “stable emulsion” used herein means that the emulsion is in a dispersed situation of thermodynamic stability, and could be placed as still under ambient condition for more than 2 months without visual phase separation, but with its reactive properties kept within this period.

The inventors of the invention found that: by taking advantage of the interaction between hydroxyl groups on the surface of nano silica and reactive groups such as alkoxysilyl and/or hydroxysilyl groups on the molecular chain of a silylated polymer, a large quantity of nano silica can be adsorbed on the surface of the silylated polymer latex particles by using post-emulsification process. The nano silica not only can serve as a Pickering emulsifying agent to stabilize the polymer latex particles, but also can inhibit the self-crosslinking of the silylated polymer in water. Then, a stable silylated polymer emulsion can be obtained only by adding a small quantity of surfactant, or even no surfactant, to the system, while no organic solvent is needed herein. Based on this, the inventors accomplished the present invention.

### Silylated Polymer Emulsion

Specifically, the present invention provides a stable low VOC silylated polymer emulsion, which comprises: (1) a silylated polymer, (2) water, (3) optional emulsifying agent, and (4) nano silica.

The emulsion herein has a solid content of preferably ≦85 wt %, more preferably 40 to 85 wt %. The emulsion can be further diluted with water to the desired extent in view of the concrete intended use. By adjusting its solid content, emulsifying agent, emulsifying aid and the like, the emulsion can be made as either oil-in-water or water-in-oil type emulsion.

The emulsion herein has latex particle size of preferably less than 3 μm, more preferably less than 1 μm.

The emulsion herein invention has a pH value of preferably 4 to 13, more preferably 5 to 10.

The low VOC silylated polymer emulsion herein can be cured to obtain a crosslinked elastomer after volatilization of water. The addition of nano silica in the emulsion plays a role of enhancing the mechanical strengths of the crosslinked film-forming polymer.

### Silylated Polymer

The silylated polymer used herein is preferably a polymer having alkoxysilyl groups at chain end(s) and/or at side chain(s), more preferably a polymer having two alkoxysilyl groups at chain end(s) and/or at side chain(s).

More specifically, the silylated polymer is preferably selected from the group consisting of: alkoxysilyl polyether, alkoxysilyl polyester, alkoxysilyl organic silicone resin such as polysiloxane, alkoxysilyl polyacrylate, alkoxysilyl polyurethane, alkoxysilyl polyolefins and any combinations thereof. The non-limiting examples of the silylated polymer include: methyldimethoxysilyl polyethylene oxide, vinyldimethoxysilyl polypropylene oxide, methyldimethoxysilyl polypropylene oxide, trimethoxysilyl polydimethylsiloxane, triethoxysilyl polydimethylsiloxane, vinyldiethoxysilyl polydimethylsiloxane, methylvinylmethoxysilyl polydimethylsiloxane, vinyldimethoxysilyl polydimethylsiloxane, vinylmethoxysilyl polymethylphenylsiloxane, ethyldimethoxysilyl polymethylphenylsiloxane, Vinyldimethoxysilyl polyester resin, vinyldiethoxysilyl polyester, vinyldimethoxysilyl polyester, methyldimethoxysilyl polyacrylate resin, methyldimethoxysilyl polyacrylate resin, methyldimethoxysilyl polyurethane, triethoxysilyl polyurethane resin and the like. Said silylated polymer could be prepared according to the general methods disclosed in, for example U.S. Pat. Nos. 5,300,608; 3,971,751; 4,374,237; 6,803,412; 5,986,014 and 6,420,492.

The silylated polymer as used herein has preferably a viscosity of 0.01 to 10,000 Pa.s (25° C.), more preferably 0.05 to 2,000 Pa.s (25° C.).

Said silylated polymers used in the present invention have preferably a weight average molecular weight (Mw) from 1000-200000, more preferably 5000-100000; molecular weight distribution (Mw/Mn) preferably from 1-3, determined by GPC method.

The silylated polymer is present in the emulsion in an amount of preferably 20 to 84 wt %, more preferably 40 to 84 wt %, based on the total weight of the emulsion.

### Water

Water is present in the emulsion in an amount of preferably 14 to 78 wt %, more preferably 14 to 60 wt %, based on the total weight of the emulsion.

### Emulsifyinq Agent

The emulsifying agent as used herein could be any conventional emulsifying agent that serves to stabilize the silylated polymer in the aqueous silylated polymer emulsion. Preferably, the emulsifying agent is selected from the group consisting of anionic surfactant, nonionic surfactant, and any combinations thereof. More preferably, the emulsifying agent is selected from anionic surfactant having a HLB value of 8 to 40, nonionic surfactant having a HLB value of 8 to 40, and any combinations thereof.

More specifically, the emulsifying agent is preferably selected from the group consisting of C8-C22 alkyl sulfonates, C8-C22 alkyl benzene sulfonates, C8-C22 alkyl sulfates, phosphates, polyether-type surfactants such as fatty alcohol polyethylene oxide and C8-C22 alkyl phenol polyethylene oxide, fatty acid amine-polyethylene oxide, hydrophilic block polymer containing emulsified silylated polymer segment, and any combinations thereof.

The emulsifying agent is preferably present in the emulsion in an amount of 0.1 to 4 wt %, more preferably 0.1 to 2 wt %, based on the total weight of the emulsion.

### Nano Silica

Nano silica as used herein has a particle size of preferably 10 to 300 nm, more preferably 10 to 200 nm. Nano silica as used herein has preferably BET specific surface area of 30 m²/g to 250 m²/g.

Nano silica as used herein is of hydroxyl groups on the surface, such as various types of hydrophilic nano silica, which include, but are not limited to, nano silica powder such as precipitated nano silica and fumed nano silica, and nano silica hydrosol. For example, nano silica hydrosol Nyacol® 9950 or Nyacol® 2040 manufactured by EKA Chemical Corporation; precipitated nano silica Ultrasil® 360 manufactured by Degussa Corporation; fumed nano silica CAB-O-SIL® M-5 manufactured by Cabot Corporation.

The nano silica is present in the emulsion in an amount of 1 to 20 wt %, preferably 2 to 12 wt %, based on the total weight of the emulsion.

### Emulsifying Aid

If desired, for instance, when it is desired to increase the hydrophilicity of the used polymers, or to increase the consistency of the produced emulsions, the emulsion herein may further comprise various suitable emulsifying aids so long as they bring no substantial adverse influence on the emulsion. The non-limiting examples of the emulsifying aid include hydrophilic aids, thickening agents, and any combinations thereof.

More specifically, the hydrophilic aid is preferably selected from water-soluble polymeric compounds, more preferably selected from the group consisting of polyvinyl pyrrolidone, polyethylene glycol, polyvinyl alcohol, polyvinyl methyl ether, and any combinations thereof.

The thickening agent is preferably selected from aqueous thickening agents, more preferably selected from the group consisting of hydroxymethyl cellulose, hydroxyethyl cellulose, bentonite, active clay, and any combinations thereof.

The emulsifying aid is present in the emulsion in an amount of preferably from >0 to ≦5 wt %, more preferably from >0 to ≦3 wt %, based on the total weight of the emulsion.

### Other Optional Ingredients

The emulsion herein may further comprise other optional ingredients so long as they bring no substantial adverse influence on the emulsion. The non-limiting examples of the optional ingredients include pigments, filler, defoaming agents, levelling agents, antioxidants, tackifiers, UV absorbents, and any combinations thereof.

More specifically, the optional ingredients include pigments, filler, defoaming agents, levelling agents, antioxidants, tackifiers and UV absorbents that are conventionally used in the products such as coatings, adhesives, sealants, cosmetics, and any combinations thereof.

### Method for Preparing the Silylated Polymer Emulsion

The method for preparing the silylated polymer emulsion herein comprises the following steps:

(1) blending a silylated polymer with an optional emulsifying agent and optional emulsifying aid;

(2) forming a homogeneous mixture containing nano silica and water;

(3) dropping the homogeneous mixture obtained in step (2) to the blend obtained in step (1) with stirring to carry out post-emulsification; and

(4) optionally, after finishing the post-emulsification, regulating the pH of the resultant emulsion to 4-13, thereby preparing the present silylated polymer emulsion.

In the preparation method, the amounts of various ingredients are controlled so as to prepare a stable oil-in-water or water-in-oil type silylated polymer emulsion. Based on the total weight of the emulsion, the amounts of various ingredients are preferably controlled as follows: 20 to 84 wt % of the silylated polymer; 14 to 78 wt % of water; >0 to ≦4 wt % of the emulsifying agent; 1 to 20 wt % of nano silica; and from >0 to ≦5 wt % of the emulsifying aid.

In step (1), at a temperature of preferably 20-95° C., the silylated polymer, the optional emulsifying agent and the optional emulsifying aid are blended in a high-speed dispersion kettle with stirring at, preferably, 1,000-3,000 rpm for, preferably, 10-30 minutes.

In step (2), at a temperature of preferably 20-95° C., a homogeneous mixture containing nano silica and water is formed in a high-speed dispersion kettle with stirring at, preferably, 1,000-3,000 rpm for preferably 10-30 minutes, and/or ultrasonic dispersing for preferably 2-20 minutes. If a purchased hydrosol is directly used, the step (2) may be eliminated.

In step (3), by controlling the system temperature at preferably 20-95° C., the homogeneous mixture obtained in step (2) is added dropwise to the blend obtained in step (1), in a high-speed dispersion kettle with stirring at, preferably, 2,000-5,000 rpm within preferably 0.5-3 hours, thereby accomplishing the post-emulsification. More preferably, after finishing the addition, the system may be further stirred at, preferably, 1,000-3,000 rpm for preferably 0.5-2 hours, while controlling the system temperature at preferably 20-95° C., thereby accomplishing the post-emulsification.

In step (4), a pH regulator is preferably used to regulate the pH value of the silylated polymer emulsion. The non-limiting examples of the preferred pH regulator include acid, base, or salt of low molecular weight, and any combinations thereof. The non-limiting examples of the suitable pH regulator include hydrochloric acid, sulfuric acid, nitric acid, ammonia water, ammonium carbonate, sodium carbonate, ammonium chloride and the like. The pH regulator is used in an amount depending on the desired pH value of the emulsion.

The preparation process of the emulsion herein has no special requirement in pressure so long as it exerts no substantial adverse influence on the preparation method. Other operation conditions possibly involved but not mentioned in the present preparation method, may be identical with those conventionally used for preparing the silylated polymer emulsion. For example, see U.S. Pat. Nos. 6,713,558 and 6,831,128.

Correspondingly, the present invention also provides a method for homogeneously dispersing nano silica in a silylated polymer, which comprises the following steps:

(1) blending a silylated polymer with an optional emulsifying agent and optional emulsifying aid;

(2) forming a homogeneous mixture containing nano silica and water;

(3) dropping the homogeneous mixture obtained in step (2) to the blend obtained in step (1) with stirring to carry out post-emulsification, thereby forming an emulsion;

(4) optionally, regulating the pH of the emulsion to 4-13 after finishing the emulsification; and,

(5) optionally, volatilizing water.

The detailed operation steps are as above described.

The stable low VOC silylated polymer emulsion and its preparation method as set forth herein have the following advantages: owing to the very strong surface activity of nano silica, and by taking advantage of the interaction between hydroxyl groups on the surface of nano silica and reactive groups such as alkoxysilyl and/or hydroxysilyl groups on the molecular chain of silylated polymer, a large quantity of nano silica can be adsorbed on the surface of the silylated polymer latex particles by using post-emulsification process. It not only can serve as a Pickering emulsifying agent to stabilize the polymer latex particles, but also can inhibit the self-crosslinking of the silylated polymer in water. Then, a stable silylated polymer emulsion can be obtained only by adding a small quantity of surfactant to the system, or even without the use of surfactant, while no organic solvent is needed herein. By using the method as above described, nano silica can be homogeneously dispersed in a silylated polymer. Also, without any surface modification, nano silica can be directly added to the silylated polymer. It has good compatibility with the silylated polymer. The prepared emulsion has a solid content of ≦85%, a particle size of less than 3 μm, and a shelf life of over half a year when stored at room temperature. In use, the emulsion can be directly diluted with water. The silylated polymer emulsion can be cured to obtain a crosslinked elastomer after volatilization of water. Further, the addition of nano silica enhances the mechanical strengths of the crosslinked elastomer. The preparation method as described herein is simple and easy-to-operate.

### Uses of the Present Emulsion

The stable low VOC silylated polymer emulsion prepared herein can be used as a raw material for coatings, adhesives, sealants, inks, skin care products, detergents and the like, and can be applied to the above products in a manner conventionally used by the silylated polymer emulsion. In use, the emulsion can be directly diluted with water to the desired extent in view of the concrete intended use.

All percentages and ratios used herein are based on weight, and all amounts of the ingredients in the emulsion are based upon the total weight of the emulsion, unless otherwise specified.

All cited publications are incorporated herein by reference in their entireties for all purposes.

### EXAMPLES

The following examples further describe and demonstrate the preferred embodiments within the scope of the present invention. The examples are given solely for the purpose of illustration, and are not to be construed as limitations of the present invention.

All steps for preparing the emulsion in the following examples are carried out under normal pressure, and the temperature involved is room temperature, unless otherwise specified.

The properties of the silylated polymer emulsion prepared herein are characterized as follows:

The viscosity of resin is measured with NDJ-1A rotary viscometer (manufactured by Shende Technological Development Co., Ltd., China) at 25±1° C.

The molecular weight is measured with Waters Breeze 1515 HPGPC (manufactured by Waters Co., USA).

The BET specific surface of nano silica was measured at 77K using an ASAP 2010 analyzer for nitrogen adsorption measurements and utilizing Barrett-Emmett-Teller (BET) for calculation of specific surface.

The average particle size of emulsion is determined with Coulter N4 Plus laser particle size analyzer (manufactured by Beckman Co., USA).

The FTIR spectrum is determined by Magna-IR™ 550 Infrared spectrometer (manufactured by Nicolet Co.).

The appearance of crosslinked polymer is observed by XL30 SEM (manufactured by Philips Co.).

The tensile strength of crosslinked polymer is determined by DXLL-10000 electron tensile tester (manufactured by Shanghai Chemical Machinery Plant, China), in which the sample having a length of 20 mm is made according to ASTM-D412 standard, and the speed of extension is 50 mm/min.

All of the determinations are conducted under ambient conditions, unless otherwise specified.

### Example 1

Formula 1 of low VOC silylated polymer emulsion

| Ingredients | Amount, wt % |
|---|---|
| 50 wt % Nano silica hydrosol | 36 |
| Triethoxysilyl polydimethylsiloxane | 61 |
| Sodium lauryl sulfate | 0.8 |
| Rhodia CO436 | 0.8 |
| Rhodia CA 897 | 1.2 |
| 10 wt % Hydrochloric acid | to pH = 8 |

61 g triethoxysilyl polydimethylsiloxane (having a molecular weight (Mw) of 60,000, provided by Henkel KGaA, Duesseldorf, Germany, see U.S. Pat. No. 5,300,608), 0.8 g sodium lauryl sulfate, 0.8 g Rhodia C0436 (anionic surfactant, a polyethylene oxide alkylphenol ether sulfate having 4 moles of ethylene oxide units, manufactured by Rhodia Co.), and 1.2 g Rhodia CA897 (nonionic surfactant, a polyethylene oxide octylphenol ether having 40 moles of ethylene oxide units, manufactured by Rhodia Co.) are added to a high speed dispersion kettle. At room temperature, the system is homogeneously mixed with stirring at 2,000 rpm for 10 minutes. By controlling the temperature at 50-60° C., 36 g 50 wt % nano silica hydrosol (Nyacol® 9950, having an average particle size of 100 nm, manufactured by EKA Chemical Co.) is dropped to the system within 2 hours with stirring at 3,000 rpm. After finishing the dropping, the system is continually stirred for 0.5 hour at 2,000 rpm, while keeping the temperature at 50-60° C. Then, 10 wt % hydrochloric acid is added till pH=8, thereby resulting in a stable low VOC silylated polymer emulsion.

The prepared silylated polymer emulsion has a solid content of 82 wt %, an average latex particle diameter of 1,930 nm, and nano silica content of 18 wt %. The emulsion can be placed as stable in room temperature over half a year, and can be diluted with water in use. The tensile strength of the crosslinked silylated polymer obtained after volatilization of water is increased by 21%, compared with that of the same but blank silylated polymer as a contrast to which no nano silica is added.

### Example 2

Formula 2 of low VOC silylated polymer emulsion

| Ingredients | Amount, wt % |
|---|---|
| Precipitated nano silica | 5 |
| Vinyldimethoxysilyl polypropylene oxide | 20 |
| Methyldimethoxysilyl polypropylene oxide | 20 |
| ICI Span 20 | 0.5 |
| ICI Brij 97 | 0.3 |
| ICI Brij 30 | 0.2 |
| Polyethylene glycol 10000 | 0.3 |
| Hydroxyethyl cellulose thickening agent | 0.1 |
| Water | 54 |
| 5 wt % nitric acid aqueous solution | to pH = 5 |

At room temperature, 5 g precipitated nano silica (Ultrasil® 360, having a specific surface area of 50 m²/g and a density of 220 g/l, manufactured by Degussa Co.) and 54 g water are mixed in a dispersion kettle with stirring at 3,000 rpm for 10 minutes, and then ultrasonic dispersing for 10 minutes to obtain an aqueous nano silica dispersion. The dispersion is ready for use in a dropping pipette. 20 g vinyldimethoxysilyl polypropylene oxide (having a viscosity of 200 Pa.s and a molecular weight (Mw) 90,000, see U.S. Pat. No. 3,971,751), 20 g methyldimethoxysilyl polypropylene oxide (having a viscosity of 50 Pa.s and a molecular weight (Mw) 20,000, see U.S. Pat. No. 3,971,751), 0.5 g ICI Span 20 (a surfactant, manufactured by ICI Co.), 0.3 g ICI Brij 97 (a surfactant, manufactured by ICI Co.), 0.2 g ICI Brij 30 (a surfactant, manufactured by ICI Co.), 0.3 g polyethylene glycol 10000, and 0.1 g hydroxyethyl cellulose thickening agent are added to a high speed dispersion kettle. At room temperature, the system is homogeneously mixed with stirring at 3,000 rpm for 30 minutes. The aqueous nano silica dispersion obtained as above is dropped to the system at room temperature within 1 hour with stirring at a 3,000 rpm. After finishing the dropping, the system is continually stirred for 0.5 hour at 3,000 rpm at room temperature. Then, 5 wt % nitric acid aqueous solution is added till pH=5, thereby resulting in a stable low VOC silylated polymer emulsion.

The prepared silylated polymer emulsion has a solid content of 46 wt %, an average latex particle diameter of 400 nm, and nano silica content of 5 wt %. The emulsion can be placed as stable in room temperature for over half a year, and can be diluted with water in use.

### Example 3

Formula 3 of low VOC silylated polymer emulsion

| Ingredients | Amount, wt % |
|---|---|
| 30 wt % Nano silica hydrosol | 30 |
| Methyldimethoxysilyl polyurethane | 48 |
| Bayer Mersolat ® H-95 | 2.8 |
| Active clay thickening agent | 0.3 |
| Water | 19 |
| 10 wt % ammonia water | to pH = 11 |

30 g 30 wt % nano silica hydrosol (Nyacol® 2040 having an average particle size of 20 nm, manufactured by EKA Chemical Co.) and 19 g water are homogeneously mixed in a dispersion kettle at 60-80° C. The obtained mixture is ready for use in a dropping pipette. 48 g methyldimethoxysilyl polyurethane (having a viscosity of 70 Pa.s and a molecular weight (Mw) 40,000, see U.S. Pat. No. 4,374,237), 2.8 g Bayer Mersolat® H-95 (an anionic surfactant, having an active content of 95% and a HLB value of 11-12, and being a mixture of different alkyl (sodium) sulfonates with an average chain length of C15, manufactured by Bayer Co.), and 0.3 g active clay thickening agent are added to a high speed dispersion kettle. The system is homogeneously mixed with stirring at 3,000 rpm at 60-80° C. for 10 minutes. While controlling the temperature at 60-80° C., the mixture of nano silica hydrosol and water obtained as above is dropped to the system within 2 hours with stirring at 4,000 rpm. After finishing the dropping, the system is continually stirred for 1 hour at 3,000 rpm while keeping the temperature at 60-80° C. Then, 10 wt % ammonia water is added till pH=11, thereby resulting in a stable low VOC silylated polymer emulsion.

The prepared silylated polymer emulsion has a solid content of 60 wt %, an average latex particle diameter of 1,730 nm, and nano silica content of 9 wt %. The emulsion can be placed as stable in room temperature for over half a year, and can be diluted with water in use. The tensile strength of the crosslinked silylated polymer obtained after volatilization of water is increased by 12%, compared with that of the same but blank silylated polymer as a contrast to which no nano silica is added.

### Example 4

Formula 4 of low VOC silylated polymer emulsion

| Ingredients | Amount, wt % |
|---|---|
| Fumed nano silica | 2 |
| Vinyldiethoxysilyl polyester | 43 |
| Triton ™ X-305 (70 wt %) | 3.2 |
| Triton X-100 | 1.3 |
| Water | 51 |
| 5 wt % nitric acid aqueous solution | to pH = 7 |

2 g fumed nano silica (CAB-O-SIL® M-5, having a particle size of 200-300 nm, manufactured by Cabot Corporation, Mass., U.S.A.) and 51 g water are mixed in a dispersion kettle with stirring at 3,000 rpm at 80-95° C. for 15 minutes, and then ultrasonic dispersing for 10 minutes to obtain an aqueous nano silica dispersion. The dispersion is ready for use in a dropping pipette. 43 g vinyldiethoxysilyl polyester (having a viscosity of 3 Pa.s and a molecular weight (Mw) 7,000, see U.S. Pat. No. 6,803,412), 3.2 g Triton™ X-305 (70 wt %) (nonionic surfactant, having a HLB value of 17.3, and being octylphenol ethoxylate, manufactured by Dow Chemical Co.), and 1.3 g Triton X-100 (nonionic surfactant, having a HLB value of 13.4, and being octylphenol ethoxylate, manufactured by Dow Chemical Co.) are added to a high speed dispersion kettle. The system is homogeneously mixed with stirring at 4,000 rpm at 80-95° C. for 30 minutes. While controlling the temperature at 80-95° C., the aqueous nano silica dispersion obtained as above is dropped to the system within 1 hour with stirring at 2,500 rpm. After finishing the dropping, the system is continually stirred for 0.5 hour at 3,000 rpm while keeping the temperature at 80-95° C. Then, 5 wt % nitric acid aqueous solution is added till pH=7, thereby resulting in a stable low VOC silylated polymer emulsion.

The prepared silylated polymer emulsion has a solid content of 48 wt %, an average latex particle diameter of 2,590 nm, and nano silica content of 2 wt %. The emulsion can be placed as stable in room temperature for over half a year, and can be diluted with water in use.

### Example 5

Formula 5 of low VOC silylated polymer emulsion

| Ingredients | Amount, wt % |
|---|---|
| 50 wt % Nano silica hydrosol | 24 |
| Ethyldimethoxysilyl polymethylphenylsiloxane | 50 |
| Sodium dodecyl benzene sulfonate | 0.3 |
| Oceanpower Disponil NP 40 | 0.2 |
| Oceanpower Disponil SUS 87 Spezial IS | 0.2 |
| Polyethylene glycol 60000 | 0.3 |
| Polyvinylpyrrolidone | 1.0 |
| Water | 24 |

At room temperature, 24 g 50 wt % nano silica hydrosol (Nyacol® 9950, having an average particle size of 100 nm, manufactured by EKA Chemical Co.) and 24 g water are mixed in a dispersion kettle to get a homogeneous mixture. The obtained mixture is ready for use in a dropping pipette. 50 g Ethyldimethoxysilyl polymethylphenylsiloxane (having a viscosity of 300 Pa.s and a molecular weight (Mw) 50,000,see U.S. Pat. No. 5,300,608), 0.3 g sodium dodecyl benzene sulfonate, 0.2 g Oceanpower Disponil NP 40 (a nonionic surfactant, having a HLB value of 17.8, and being nonylphenol polyethylene oxide having 40 moles of ethylene oxide units, manufactured by Haichuan Co., Ltd., China), 0.2 g Oceanpower Disponil SUS 87 Spezial IS (an anionic surfactant, having an active content of 31 wt %, having a CMC of 1.60, and a surface tension of 27.70 mN/m at 25° C., and being a succinosulfonate, manufactured by Haichuan Co., Ltd., China), 0.3 g polyethylene glycol 60000, and 1.0 g polyvinylpyrrolidone (Tradename K30, 98 wt %, homopolymer of vinylpyrrolidone, K value: 27-33) are added to a high speed dispersion kettle. The system is homogeneously mixed with stirring at 3,000 rpm at room temperature for 30 minutes. At room temperature, the homogeneous mixture of nano silica hydrosol and water obtained as above is dropped to the system within 2 hours with stirring at 4,000 rpm. After finishing the dropping, the system is continually stirred for 1 hour at 3,000 rpm at room temperature, thereby resulting in a stable low VOC silylated polymer emulsion.

The prepared silylated polymer emulsion has a solid content of 64 wt %, an average latex particle diameter of 680 nm, and nano silica content of 12 wt %. The emulsion can be placed as stable in room temperature for over half a year, and can be diluted with water in use. The tensile strength of the crosslinked silylated polymer obtained after volatilization of water is increased by 15%, compared with that of the same but blank silylated polymer as a contrast to which no nano silica is added.

### Example 6

Formula 6 of low VOC silylated polymer emulsion

| Ingredients | Amount, wt % |
|---|---|
| Fumed nano silica | 15 |
| Methyldiethoxysilyl polyacrylate | 20 |
| Sodium dodecyl benzene sulfonate | 0.2 |
| Water | 65 |
| 10 wt % ammonia water | to pH = 8 |

15 g fumed nano silica (CAB-O-SIL® M-5, having a particle size of 200-300 nm, manufactured by Cabot Corporation, Mass., U.S.A.) and 65 g water are mixed in a dispersion kettle with stirring at 3,000 rpm at 90-95° C. for 20 minutes, and then ultrasonic dispersing for 5 minutes to obtain an aqueous nano silica dispersion. The dispersion is ready for use in a dropping pipette. 20 g methyldimethoxysilyl polyacrylate (having a viscosity of 1,500 Pa.s and a molecular weight (Mw) 110,000, see U.S. Pat. Nos. 5,986,014 and 6,420,492), and 0.2 g sodium dodecyl benzene sulfonate are added to a high speed dispersion kettle. The system is homogeneously mixed with stirring at 3,000 rpm at room temperature for 30 minutes. While controlling the temperature at 90-95° C., the aqueous nano silica dispersion obtained as above is dropped to the system within 1 hour with stirring at 4,000 rpm. After finishing the dropping, the system is continually stirred for 1 hour at 3,000 rpm while keeping the temperature at 90-95° C. Then, 10 wt % ammonia water is added till pH=8, thereby resulting in a stable low VOC silylated polymer emulsion.

The prepared silylated polymer emulsion has a solid content of 35 wt %, an average latex particle diameter of 1,170 nm, and nano silica content of 15 wt %. The emulsion can be placed as stable in room temperature for over half a year, and can be diluted with water in use. The tensile strength of the crosslinked silylated polymer obtained after volatilization of water is increased by 17%, compared with that of the same but blank silylated polymer as a contrast to which no nano silica is added.

### Example 7

Formula 7 of low VOC silylated polymer emulsion

| Ingredients | Amount, wt % |
|---|---|
| Precipitated nano silica | 10 |
| Vinyldimethoxysilyl polydimethylsiloxane | 60 |
| Bentonite | 1.2 |
| Water | 29 |
| 10 wt % ammonia water | to pH = 7 |

At a temperature of 50-65° C., 10 g precipitated nano silica (Ultrasil® 360, having a specific surface area of 50 m²/g and a density of 220 g/l, manufactured by Degussa Co.), and 29 g water are mixed in a dispersion kettle by ultrasonic dispersing for 20 minutes to obtain an aqueous nano silica dispersion. The dispersion is ready for use in a dropping pipette. 60 g vinyldimethoxysilyl polydimethylsiloxane (having a viscosity of 1.2 Pa.s and a molecular weight (Mw) 12,000, provided by Henkel KGaA, Duesseldorf, Germany□see U.S. Pat. No. 5,300,608) and 1.2 g bentonite are added to a high speed dispersion kettle, and homogeneously mixed with stirring at 3,000 rpm at room temperature for 30 minutes. While controlling the temperature at 50-65° C., the aqueous nano silica dispersion obtained as above is dropped to the system within 2 hour with stirring at 4,000 rpm. After finishing the dropping, the system is continually stirred for 0.5 hour at 3,000 rpm while keeping the temperature at 50-65° C. Then, 10 wt % ammonia water is added till pH=7, thereby resulting in a stable low VOC silylated polymer emulsion.

The prepared silylated polymer emulsion has a solid content of 35 wt %, an average latex particle diameter of 1,170 nm, and nano silica content of 15 wt %. The emulsion can be placed as stable in room temperature for over half a year, and can be diluted with water in use. The tensile strength of the crosslinked silylated polymer obtained after volatilization of water is increased by 15%, compared with that of the same but blank silylated polymer as a contrast to which no nano silica is added.

1. A silylated polymer emulsion, which comprises:
(1) silylated polymer;
(2) water;
(3) nano silica; and
(4) optionally an emulsifying agent.

2. An emulsion according to claim 1, wherein said silylated polymer is a polymer having alkoxysilyl groups at chain end(s) and/or at side chain(s).

3. An emulsion according to claim 2, wherein said silylated polymer is selected from the group consisting of alkoxysilyl polyether, alkoxysilyl polyester, alkoxysilyl organic silicone resin, alkoxysilyl polyacrylate, alkoxysilyl polyurethane, alkoxysilyl polyolefin and any combinations thereof.

4. An emulsion according to claim 1, wherein said silylated polymer has a viscosity of 0.01 to 10,000 Pa.s at 25° C.

5. An emulsion according to claim 1, wherein said silylated polymer has a weight average molecular weight of 1000-200000, and molecular weight distribution of 1-3, determined by GPC method.

6. An emulsion according to claim 1, wherein said silylated polymer is present in the emulsion in an amount of 20 to 84 wt %, based on the total weight of the emulsion.

7. An emulsion according to claim 1, wherein said water is present in the emulsion in an amount 14 to 78 wt %, based on the total weight of the emulsion.

8. An emulsion according to claim 1, wherein said emulsifying agent is selected from the group consisting of anionic surfactant, nonionic surfactant, and any combinations thereof.

9. An emulsion according to claim 8, wherein said emulsifying agent is selected from anionic surfactant having a HLB value of 8 to 40, nonionic surfactant having a HLB value of 8 to 40, and any combinations thereof.

10. An emulsion according to claim 8, wherein said emulsifying agent is selected from the group consisting of C8-C22 alkyl sulfonates, C8-C22 alkyl benzene sulfonates, C8-C22 alkyl sulfates, phosphates, polyether-type surfactants, fatty acid amine-polyethylene oxide, hydrophilic block polymer containing emulsified silylated polymer segment, and any combinations thereof.

11. An emulsion according to claim 1, wherein said emulsifying agent is present in the emulsion in an amount of 0.1 to 4 wt %, based on the total weight of the emulsion.

12. An emulsion according to claim 1, wherein said nano silica has a particle size of 10 to 300 nm.

13. An emulsion according to claim 1, wherein said nano silica has a BET specific surface area of 30 m²/g to 250 m²/g.

14. An emulsion according to claim 1, wherein said nano silica is nano silica powder or nano silica hydrosol having hydroxyl groups on the surface.

15. An emulsion according to claim 1, wherein said nano silica is present in the emulsion in an amount of 1 to 20 wt %, based on the total weight of the emulsion.

16. An emulsion according to claim 1, wherein said emulsion further comprises emulsifying aid.

17. An emulsion according to claim 16, wherein said emulsifying aid is selected from the group consisting of hydrophilic aids, thickening agents, and any combinations thereof.

18. An emulsion according to claim 17, wherein said hydrophilic aids are water-soluble polymeric compounds.

19. (canceled)

20. An emulsion according to claim 16, wherein said emulsifying aid is present in the emulsion in an amount of from >0 to ≦5 wt %, based on the total weight of the emulsion.

21. An emulsion according to claim 1, wherein said emulsion has a pH of 4-13.

22. An emulsion according to claim 1, wherein said emulsion has a solid content of ≦85 wt %.

23. An emulsion according to claim 22, wherein said emulsion has a solid content of 40 to 85 wt %.

24. An emulsion according to claim 1, wherein said emulsion has latex particle size of less than 3 μm.

25. An emulsion according to claim 24, wherein said emulsion has latex particle size of less than 1 μm.

26-27. (canceled)

28. A method for preparing a silylated polymer emulsion according to claim 1, which comprises the following steps:
(1) blending a silylated polymer with an optional emulsifying agent and optional emulsifying aid;
(2) forming a homogeneous mixture containing nano silica and water;
(3) dropping the homogeneous mixture obtained in step
(2) to the blend obtained in step (1) with stirring to carry out post-emulsification; and
(4) optionally, after finishing the emulsification, regulating the pH of the resultant emulsion to 4-13.

29. A method according to claim 28, wherein, based on the total weight of the emulsion, the amounts of various ingredients are as follows: 20 to 84 wt % of the silylated polymer; 14 to 78 wt % of water; >0 to ≦4 wt % of the emulsifying agent; 1 to 20 wt % of nano silica; and from >0 to ≦5 wt % of the emulsifying aid.

30. A method according to claim 28, wherein the blending in step (1) is accomplished with stirring at 1,000-3,000 rpm at a temperature of 20-95° C. for 10-30 minutes.

31. A method according to claim 28, wherein, in step (2), a homogeneous mixture containing nano silica and water is formed with stirring at 1,000-3,000 rpm at a temperature of 20-95° C. for 10-30 minutes and/or ultrasonic dispersing for 2-20 minutes.

32. A method according to claim 28, wherein, in step (3), the homogeneous mixture obtained in step (2) is dropped to the blend obtained in step (1) with stirring at 2,000-5,000 rpm at a temperature of 20-95° C. within 0.5-3 hours; and optionally, after finishing the dropping, the system is further stirred at 1,000-3,000 rpm at a temperature of 20-95° C. for 0.5-2 hours, thereby accomplishing the post-emulsification.

33. A method according to claim 28, wherein a pH regulator is added to regulate the pH of the emulsion, said pH regulator is selected from the group consisting of acid, base, or salt of low molecular weight, and any combinations thereof.

34. A method for homogeneously dispersing nano silica into a silylated polymer, which comprises the following steps:
(1) blending a silylated polymer with an optional emulsifying agent and optional emulsifying aid;
(2) forming a homogeneous mixture containing nano silica and water;
(3) dropping the homogeneous mixture obtained in step (2) to the blend obtained in step (1) with stirring to carry out post-emulsification, thereby forming an emulsion;
(4) optionally, regulating the pH of the emulsion to 4-13 after finishing the emulsification; and,
(5) optionally, volatilizing water.

35. (canceled)
